(19) United States
(12) Patent Application Publication
(10) Pub. No.: US 2020/0074483 A1
(43) Pub. Date: Mar. 5, 2020

(54) INFORMATION PROVIDING APPARATUS, METHOD OF PROVIDING INFORMATION, AND NON-TRANSITORY STORAGE MEDIUM

(71) Applicant: NEC CORPORATION, Tokyo (JP)

(72) Inventor: Tomoaki IWASAKI, Tokyo (JP)

(73) Assignee: NEC CORPORATION, Tokyo (JP)

(21) Appl. No.: 16/493,813

(22) PCT Filed: Dec. 11, 2017
(86) PCT No.: PCT/JP2017/044403

§ 371 Date: Sep. 13, 2019

(30) Foreign Application Priority Data
Mar. 17, 2017 (JP) 2017-052264

(51) Int. Cl. G06Q 30/02; G06Q 20/20; G06Q 30/06; G06Q 10/08

(52) U.S. Cl. CPC G06Q 30/0201; G06Q 20/20; G06Q 10/087; G06Q 30/0269; G06Q 30/0204; G06Q 30/06

(57) ABSTRACT

An information providing apparatus including an acquisition unit that acquires real-time sales-or-eating-establishment information from an apparatus in a sales or eating establishment, and a user terminal that a customer carries in the establishment; a determination unit that, on the basis of the information, determines a situation of the establishment which includes at least one of a ratio between male and female customers present, a rate of customers per age bracket, a noise annoyance, the presence or absence of a child, a rate of children, the presence or absence of a customer who is smoking, a rate of customers who are smoking, the presence or absence of an unoccupied smoking seat, the presence or absence of an unoccupied no-smoking seat, an out-of-stock item, and a future congested situation; and an output unit that outputs a result of the determination.

### TECHNICAL FIELD

The present invention relates to an information providing apparatus, a method of providing information, and program.

### BACKGROUND ART

In Patent Document 1, an apparatus is disclosed which acquires a position of a portable terminal that each person carries with him/her from Differential Positioning System (DGPS) and a base station, calculates the number of persons who carry the portable terminal with themselves in a certain place and a congestion rate in the place, on the basis of the information, and provides a result of the calculation to a user. Furthermore, it is disclosed that the apparatus predicts a future congestion rate from a current congested situation and past data and provides the predicted future congestion rate to the user.

In Non-Patent Document 1, a technology (a heterogeneous mixture learning technology) is disclosed which relates to a model (a heterogeneous mixture prediction model) in which pieces of input data are case-divided according to a rule in the form of a decision tree and prediction is made with a linear model in which explanatory variables different for each case are combined.

### RELATED DOCUMENT

### Patent Document

[Patent Document 1] Japanese Patent Application Publication No. 2002-288385

[Non-patent Document 1] “Biggu deta wo sasaeru senshin gijutsu, Ishu kongo gakusyu (Advanced Technology supporting big data, Heterogeneous Mixture Learning)”, [online], NEC Corporation, [search on Apr. 26, 2016], the Internet <URL: http://jpn.nec.com/bigdata/analyze/index.html>

### SUMMARY OF THE INVENTION

### Technical Problem

The user can determine whether or not he/she will go to a place, considering not only a current congested situation and a future congestion rate, but also current other situations in the place. The technology disclosed in Patent Document 1 can provide the current congested situation or the future congestion rate, but cannot provide information other than these. An object of the present invention is to provide a new technology of determining a current situation in a certain place.

### Solution to Problem

According to an aspect of the present invention, there is provided an information providing apparatus, including: an acquisition unit that acquires real-time sales-or-eating-establishment information from at least one of an apparatus that is installed in a sales or eating establishment, and a user terminal that a customer carries with him/her in the sales or eating establishment; a determination unit that, on the basis of the real-time sales-or-eating-establishment information, determines a situation of the sales or eating establishment which includes at least one of a ratio between male customers and female customers present in the sales or eating establishment, a rate of customers in the sales or eating establishment per age bracket, a noise annoyance in the sales or eating establishment, the presence or absence of a child in the sales or eating establishment, a rate of children in the sales or eating establishment, the presence or absence of a customer who is smoking in the sales or eating establishment, a rate of customers who are smoking in the sales or eating establishment, the presence or absence of an unoccupied smoking seat in the sales or eating establishment, the presence or absence of an unoccupied no-smoking seat in the sales or eating establishment, an out-of-stock item, and a future congested situation of the sales or eating establishment; and an output unit that outputs a result of the determination by the determination unit.

Furthermore, according to another aspect of the present invention, there is provided a method of providing information, which is performed by a computer, the method including: a process of acquiring real-time sales-or-eating-establishment information from at least one of an apparatus that is installed in a sales or eating establishment, and a user terminal that a customer carries with him/her in the sales or eating establishment; a process of determining a situation of the sales or eating establishment which includes at least one of a ratio between male customers and female customers present in the sales or eating establishment, a rate of customers in the sales or eating establishment per age bracket, a noise annoyance in the sales or eating establishment, the presence or absence of a child in the sales or eating establishment, a rate of children in the sales or eating establishment, the presence or absence of a customer who is smoking in the sales or eating establishment, a rate of customers who are smoking in the sales or eating establishment, the presence or absence of an unoccupied smoking seat in the sales or eating establishment, the presence or absence of an unoccupied no-smoking seat in the sales or eating establishment, an out-of-stock item, and a future congested situation of the sales or eating establishment, on the basis of the real-time sales-or-eating-establishment information; and a process of outputting a result of the determination in the determination process.

Furthermore, according to still another aspect of the present invention, there is provided a program that causes a computer to function as: an acquisition unit that acquires real-time sales-or-eating-establishment information from at least one of an apparatus that is installed in a sales or eating establishment, and a user terminal that a customer carries with him/her in the sales or eating establishment; a determination unit that determines a situation of the sales or eating establishment which includes at least one of a ratio between male customers and female customers present in the sales or eating establishment, a rate of customers in the sales or eating establishment per age bracket, a noise annoyance in the sales or eating establishment, the presence or absence of a child in the sales or eating establishment, a rate of children in the sales or eating establishment, the presence or absence of a customer who is smoking in the sales or eating establishment, a rate of customers who are smoking in the sales or eating establishment, the presence or absence of an unoccupied smoking seat in the sales or eating establishment, the presence or absence of an unoccupied no-smoking seat in the sales or eating establishment, an out-of-stock item, and a future congested situation of the sales or eating establishment, on the basis of the real-time sales-or-eating-establishment information; and an output unit that outputs a result of the determination by the determination unit.

### Advantageous Effects of Invention

According to the present invention, a new technology of determining a current situation in a certain place.

### BRIEF DESCRIPTION OF THE DRAWINGS

The object described above and other objects, and features and advantages are further made apparent by suitable example embodiments that will be described below and the following drawings that accompany such example embodiments.

FIG. 1 is an example of a functional block diagram illustrating an image of an entire information providing system according to the present example embodiment.

FIG. 2 is a diagram schematically illustrating an example of a hardware configuration of the information providing apparatus according to the present example embodiment.

FIG. 3 is an example of a functional block diagram of the information providing apparatus according to the present example embodiment.

FIG. 4 is a diagram schematically illustrating an example of information that is processed by the information providing apparatus according to the present example embodiment.

FIG. 5 is a flowchart illustrating an example of a processing flow of the information providing apparatus according to the present example embodiment.

FIG. 6 is an example of the functional block diagram of the information providing apparatus according to the present example embodiment.

FIG. 7 is an example of the functional block diagram of the information providing apparatus according to the present example embodiment.

### DESCRIPTION OF EMBODIMENTS

### First Example Embodiment

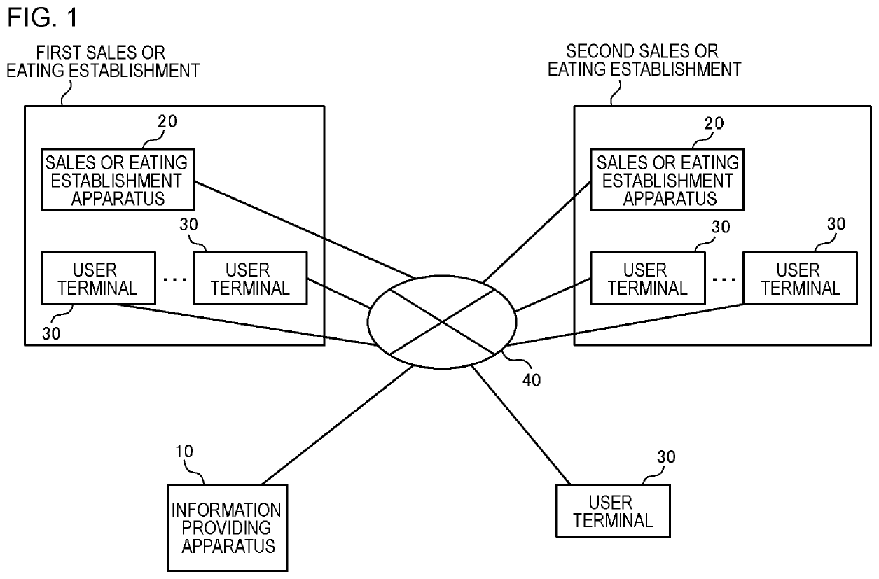

First, an outline of an information providing system according to the present example embodiment will be described with reference to FIG. 1. As illustrated, the information providing system has an information providing apparatus 10, a sales or eating establishment apparatus 20, and a user terminal 30. These apparatuses are linked to each other, for example, through a communication network 40 such as the Internet and transmit and receive information to and from each other.

The information providing apparatus 10 acquires real-time sales-or-eating-establishment information from at least one of the sales or eating establishment apparatus 20 and the user terminal 30 that a customer carries with him/her in a sales or eating establishment. The real-time sales-or-eating-establishment information is information for determining a current situation of the sales or eating establishment. That is, the information providing apparatus 10 acquires real-time sales-or-eating-establishment information for determining a current situation of a first sales or eating establishment, from at least one of the sales or eating establishment apparatus 20 in the first sales or eating establishment and the user terminal 30 that a customer carries with him/her in the first sales or eating establishment. Furthermore, the information providing apparatus 10 acquires real-time sales-or-eating-establishment information for determining a current situation of a second sales or eating establishment, from at least one of the sales or eating establishment apparatus 20 in the second sales or eating establishment and the user terminal 30 that a customer carries with him/her in the second sales or eating establishment. It should be noted that, in a case where the information providing apparatus 10 acquires the real-time sales-or-eating-establishment information from the user terminal 30 that the customer carries with him/her in the sales or eating establishment and does not acquire the real-time sales-or-eating-establishment information from the sales or eating establishment apparatus 20, the information providing system may not have the sales or eating establishment apparatus 20.

Then, the information providing apparatus 10 determines the situation of each sales or eating establishment on the basis of the real-time sales-or-eating-establishment information. For example, the information providing apparatus 10 determines a current situation of the sales or eating establishment that includes at least one of a ratio between male customers and female customers present in the sales or eating establishment, a rate of customers in the sales or eating establishment per age bracket, a noise annoyance in the sales or eating establishment, the presence or absence of a child in the sales or eating establishment, a rate of children in the sales or eating establishment, the presence or absence of a customer who is smoking in the sales or eating establishment, a rate of customers who are smoking in the sales or eating establishment, the presence or absence of an unoccupied smoking seat in the sales or eating establishment, the presence or absence of an unoccupied no-smoking seat in the sales or eating establishment, an out-of-stock item, and a future congested situation of the sales or eating establishment.

Furthermore, the information providing apparatus 10 provides information beneficial to a user, using the result of the determination, which is described above. For example, the information providing apparatus 10 may provide the user with the latest result of the determination in the sales or eating establishment which is specified by the user, and may provide information for identifying a sales or eating establishment having the latest result of the determination that satisfies a search condition specified by the user.

Next, a configuration of each apparatus will be described.

The sales or eating establishment apparatus 20 is an apparatus that is installed in the sales or eating establishment. The sales or eating establishment apparatus 20 has a unit that acquires real-time sales-or-eating-establishment information for determining a current situation of the sales or eating establishment, and a unit that transmits the real-time sales-or-eating-establishment information to the information providing apparatus 10. The sales or eating establishment apparatus 20, for example, may include at least one of a camera, a microphone, and a point of sales (POS) system.

The user terminal 30 has a unit that acquires real-time sales-or-eating-establishment information for determining a current situation of the sales or eating establishment, a unit that transmits a request for the real-time sales-or-eating-establishment information or information, and a unit that receives a response to the request for the information. Examples of the user terminal 30 include a smartphone, a tablet, a portable telephone, a personal computer (PC), and the like, but no limitation to these is imposed.

Next, a configuration of the information providing apparatus 10 will be described. First, an example of a hardware configuration of the information providing apparatus 10 will be described. An information providing apparatus 10 is realized by an arbitrary combination of primary hardware and software components, that is, a Central Processing unit (CPU) of an arbitrary computer, a memory, a program that is loaded into the memory, a storage unit (in which a program that is downloaded from a recording medium such as a Compact Disc (CD) or a server or like on the Internet can be stored in addition to a program that had been stored in advance at the time of shipping the apparatus), such as a hard disk on which the program is stored, and a network connection interface. Then, it is apparent to a person of ordinary skill in the art that various modifications to a method and an apparatus for such realization are present.

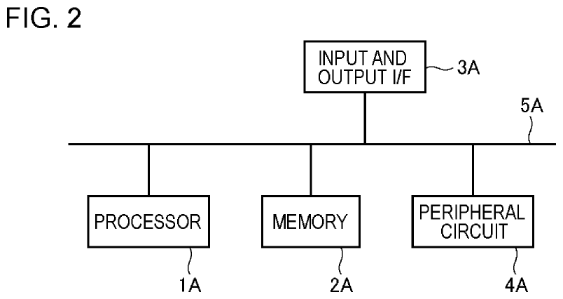

FIG. 2 is a block diagram illustrating a hardware configuration of the information providing apparatus 10 according to the present example embodiment. As illustrated in FIG. 2, the information providing apparatus 10 has a processor 1A, a memory 2A, an input and output interface 3A, a peripheral circuit 4A, and a bus 5A. Various modules are included in the peripheral circuit 4A.

The bus 5A is a data transfer path along which the processor 1A, the memory 2A, the peripheral circuit 4A and the input and output interface 3A transmit and receive data to and from each other. The processor 1A, for example, is an arithmetic operation device such as Central Processing Unit (CPU) or Graphics Processing Unit (GPU). The memory 2A, for example, is a memory such as a Random Access Memory (RAM) or a Read Only Memory (ROM). The input and output interfaces 3A include an interface for acquiring information from an input devices (for example, a keyboard, a mouse, a microphone, a physical key, a touch panel display, a code reader, and the like), an external apparatus, an external server, an external sensor or the like, or an interface for outputting information to output devices (for example, a display, a speaker, a printer, an emailer, and the like), an external apparatus, an external server or the like. The processor 1A can output a command to each module, and, on the basis of results of arithmetic operations, can perform an arithmetic operation.

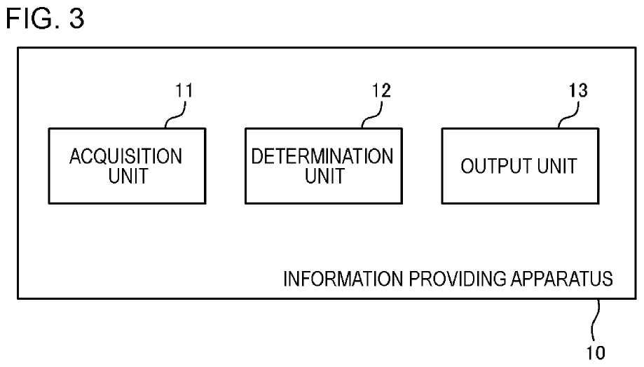

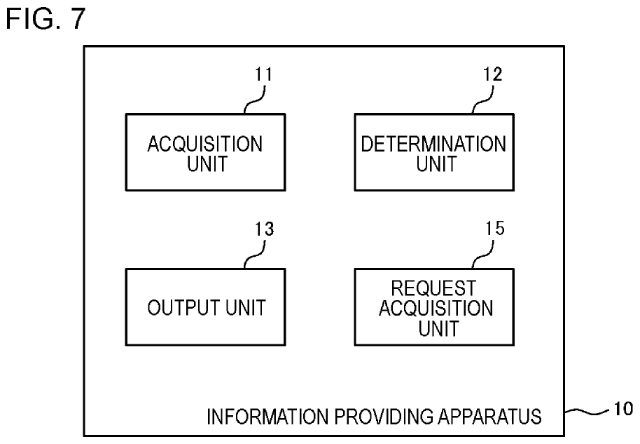

FIG. 3 illustrates an example of a functional block diagram of the information providing apparatus 10 according to the present example embodiment. As illustrated, the information providing apparatus 10 has an acquisition unit 11, a determination unit 12, and an output unit 13. FIG. 7 illustrates another example of a functional block diagram of the information providing apparatus 10 according to the present example embodiment. As illustrated, the information providing apparatus 10 may further have a request acquisition unit 15.

The acquisition unit 11 acquires the real-time sales-or-eating-establishment information from at least one of the sales or eating establishment apparatus 20 that is installed in the sales or eating establishment, and the user terminal 30 that the customer carries with him/her in the sales or eating establishment.

On the basis of the real-time sales-or-eating-establishment information, the determination unit 12 determines a situation of the sales or eating establishment that includes at least one of the ratio between male customers and female customers present in the sales or eating establishment, the rate of customers in the sales or eating establishment per age bracket, the noise annoyance in the sales or eating establishment, the presence or absence of a child in the sales or eating establishment, the rate of children in the sales or eating establishment, the presence or absence of a customer who is smoking in the sales or eating establishment, the rate of customers who are smoking in the sales or eating establishment, the presence or absence of an unoccupied smoking seat in the sales or eating establishment, the presence or absence of an unoccupied no-smoking seat in the sales or eating establishment, the out-of-stock item, and the future congested situation of the sales or eating establishment.

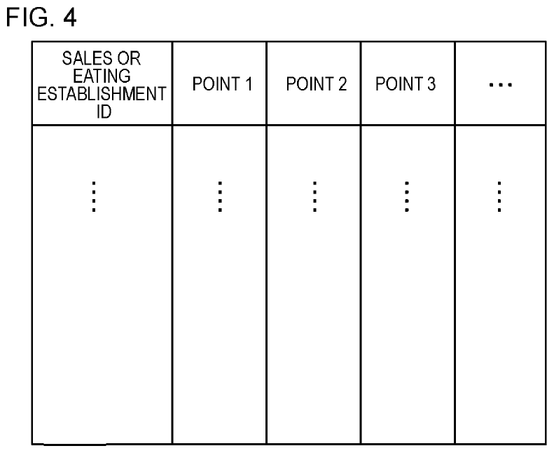

On the basis of a result of the determination by the determination unit 12, the information providing apparatus 10 manages information as illustrated in FIG. 4. In the information illustrated in the FIG. 4, the latest values (the latest results of the determination) of plural points are associated with a sales or eating establishment identifier (ID). The points, for example, are a ratio between male customers and female customers present in the sales or eating establishment, a rate of customers in the sales or eating establishment per age bracket, a noise annoyance in the sales or eating establishment, the presence or absence of a child in the sales or eating establishment, a rate of children in the sales or eating establishment, the presence or absence of a customer who is smoking in the sales or eating establishment, a rate of customers who are smoking in the sales or eating establishment, the presence or absence of an unoccupied smoking seat in the sales or eating establishment, the presence or absence of an unoccupied no-smoking seat in the sales or eating establishment, and an out-of-stock item. The pieces of information are updated at any time.

A specific example of the real-time sales-or-eating-establishment information, and a specific example of a process of determining a current situation of the sales or eating establishment on the basis of the real-time sales-or-eating-establishment information will be described below.

### SPECIFIC EXAMPLE 1

For example, the acquisition unit 11 may acquire image data, which is generated by at least one of a camera (the sales or eating establishment apparatus 20) that is installed in the sales or eating establishment and the user terminal 30 that the customer carries with him/her in the sales or eating establishment, as the real-time sales-or-eating-establishment information. Then, on the basis of the image data, the determination unit 12 may determine a situation of the sales or eating establishment that includes at least one of the ratio between male customers and female customers present in the sales or eating establishment, the rate of customers in the sales or eating establishment per age bracket, the presence or absence of a child in the sales or eating establishment, the rate of children in the sales or eating establishment, the presence or absence of a customer who is smoking in the sales or eating establishment, the rate of customers who are smoking in the sales or eating establishment, the presence or absence of an unoccupied smoking seat in the sales or eating establishment, and the presence or absence of an unoccupied no-smoking seat in the sales or eating establishment. A specific example will be described below.

### SPECIFIC EXAMPLE 1-1

The camera that is installed in the sales or eating establishment may be installed in the doorway of the sales or eating establishment in such a manner at to image-capture a person who goes into and out of the sales or eating establishment. In this case, the camera may generate data of a moving image. One camera may be installed, and multiple cameras may be installed. The image data that is generated is transmitted from the sales or eating establishment apparatus 20 to the information providing apparatus 10 with as little time loss as possible after the image data is generated.

The determination unit 12 analyzes the acquired image data and extracts a person who goes into the sales or eating establishment and a person who goes out of the sales or eating establishment. Furthermore, on the basis of a feature of an appearance of each person, the determination unit 12 determines whether or not the person is a customer or a staff member of the sales or eating establishment. For example, a feature (for example, a face feature value or a dress feature value, or the like) of the appearance of the staff of the sales or eating establishment may be registered in advance. Then, the determination unit 12 may determine whether or not each of the extracted persons is a staff member of the sales or eating establishment, using the information. The determination unit 12 determines the person who is not determined as a staff member of the sales or eating establishment, as a customer.

Furthermore, on the basis of the feature of the appearance of each person that is determined as a customer, the determination unit 12 estimates attributes (for example, gender, an age bracket, and the like). Then, on the basis of a result of the analysis, the determination unit 12 manages the number of customers in the sales or eating establishment and attributes (for example, a gender, an age bracket, and the like) of each customer.

On the basis of information that is managed, the determination unit 12 can determine a situation of the sales or eating establishment that includes at least one of the ratio between male customers and female customers present in the sales or eating establishment, the ratio of customers present in the sales or eating establishment per age bracket, the presence or absence of a child in the sales or eating establishment, and the rate of children in the sales or eating establishment (which equals to the number of children/the number of customers). An age under which a person is determined as a child is a matter that is to be determined in design (the same is hereinafter true).

### SPECIFIC EXAMPLE 1-2

In addition, the camera that is installed in the sales or eating establishment may be installed in such a manner as to image-capture the entire sales or eating establishment. In this case, the camera may generate data of a moving image and may generate data of a still image at a prescribed time interval. One camera may be installed, and multiple cameras may be installed. That is, the entire sales or eating establishment may be image-captured with multiple cameras. The image data that is generated is transmitted from the sales or eating establishment apparatus 20 to the information providing apparatus 10 with as little time loss as possible after the image data is generated.

The determination unit 12 analyzes the acquired image data and extracts a person who is present in the sales or eating establishment (a person in the image). Furthermore, on the basis of a feature of an appearance of each person, the determination unit 12 determines whether or not the person is a customer or a staff member of the sales or eating establishment. For example, a feature (for example, a face feature value or a dress feature value, or the like) of the appearance of the staff may be registered in advance. Then, the determination unit 12 may determine whether or not each of the extracted persons is a staff member of the sales or eating establishment, using the information. The determination unit 12 determines the person who is not determined as a staff member of the sales or eating establishment is, as a customer.

Furthermore, on the basis of the feature of the appearance of each person that is determined as a customer, the determination unit 12 estimates attributes (for example, gender, an age bracket, and the like). Then, on the basis of a result of the analysis, the determination unit 12 manages the number of customers in the sales or eating establishment and attributes (for example, a gender, an age bracket, and the like) of each customer.

On the basis of information that is managed, the determination unit 12 can determine a situation of the sales or eating establishment that includes at least one of the ratio between male customers and female customers present in the sales or eating establishment, the ratio of customers present in the sales or eating establishment per age bracket, the presence or absence of a child in the sales or eating establishment, and the rate of children in the sales or eating establishment.

It should be noted that, in the case of the example, instead of the image data that is generated by the camera (the sales or eating establishment apparatus 20) which is installed in the sales or eating establishment, the process described above may be performed using image data that is generated by the user terminal 30 that the customer carries with him/her in the sales or eating establishment. When the user image-captures an entire sales or eating establishment using the user terminal 30, the user transmits image data from the user terminal 30 to the information providing apparatus 10, in association with information for identifying the sales or eating establishment (a sales or eating establishment on which information is to be provided) or a type of image (for example, an image that results from image-capturing the entire sales or eating establishment).

In this case, the determination unit 12 determines whether or not to use the image data as the information for determining a current situation of the sales or eating establishment, using metadata (for example, a place of image-capturing, the date and time of image-capturing, and the like) of the image data that is acquired from the user terminal 30.

For example, it may be determined whether or not the place of image-capturing that is included in the metadata is within the sales or eating establishment on which information is to be provided. Then, in a case where the place of image-capturing is within the sales or eating establishment on which information is to be provided, the image data may be used as the information for determining a current situation of the sales or eating establishment on which information is to be provided. In a case where the place of image-capturing is not within the sales or eating establishment on which information is to be provided, the image data may not be used as the information for determining a current situation of the sales or eating establishment on which information is to be provided.

In addition, in a case where a difference between the date and time of image-capturing that is included in the metadata and current date and time is equal to or less than a prescribed value, the image data may be used as the information for determining a current situation of the sales or eating establishment on which information is to be provided. In a case where the difference described above is more than the prescribed value, the image data may not be used as the information for determining a current situation of the sales or eating establishment on which information is to be provided.

Accordingly, a current situation of the sales or eating establishment can be determined using only reliable information. As a result, the reliability of information that is provided from the information providing apparatus 10 is improved.

### SPECIFIC EXAMPLE 1-3

In addition, the camera that is installed in the sales or eating establishment may be installed in such a manner as to image-capture all smoking seats or all no-smoking seats in the sales or eating establishment. In this case, the camera may generate data of a moving image and may generate data of a still image at a prescribed time interval. One camera may be installed, and multiple cameras may be installed. That is, all smoking seats or all no-smoking seats in the sales or eating establishment may be image-captured with multiple cameras. The image data that is generated is transmitted from the sales or eating establishment apparatus 20 to the information providing apparatus 10 with as little time loss as possible after the image data is generated.

The determination unit 12 analyzes the acquired image data and extracts a person who sits on a smoking seat or a no-smoking seat (a person in the image). Furthermore, the determination unit 12 retains the number of smoking seats or no-smoking seats in advance. Then, on the basis of the number of persons sitting on the smoking seats or the no-smoking seats and the number of smoking seats or no-smoking seats, the determination unit 12 determines a situation of the sales or eating establishment that includes the presence or absence of an unoccupied smoking seat and a no-smoking seat. For example, in a case where the number of persons sitting on the smoking seats or the no-smoking seats is smaller than the number of smoking seats or no-smoking seats, it is determined that a smoking seat or a no-smoking seat is unoccupied.

It should be noted that, in the case of the example, instead of the image data that is generated by the camera (the sales or eating establishment apparatus 20) which is installed in the sales or eating establishment, the process described above may be performed using image data that is generated by the user terminal 30 that the customer carries with him/her in the sales or eating establishment. When the user image-captures all smoking seats or all no-smoking seats in the sales or eating establishment using the user terminal 30, the user transmits image data on all smoking seats or all no-smoking seats from the user terminal 30 to the information providing apparatus 10, in association with information for identifying the sales or eating establishment (the sales or eating establishment on which information is to be provided) or a type of image (for example, an image that results from image-capturing all smoking seats in the sales or eating establishment or an image that results from image-capturing all no-smoking seats).

In this case, the determination unit 12 determines whether or not to use the image data as the information for determining a current situation of the sales or eating establishment, using metadata of the image data that is acquired from the user terminal 30. A specific example of determination process is the same as that described above.

### SPECIFIC EXAMPLE 1-4

In addition, the camera that is installed in the sales or eating establishment may be installed in such a manner as to image-capture the top of each table in the sales or eating establishment. In this case, the camera may generate data of a moving image and may generate data of a still image at a prescribed time interval. One camera may be installed, and multiple cameras may be installed. That is, the tops of all tables in the sales or eating establishment may be image-captured with multiple cameras. The image data that is generated is transmitted from the sales or eating establishment apparatus 20 to the information providing apparatus 10 with as little time loss as possible after the image data is generated.

The determination unit 12 analyzes the acquired image data and extracts an ashtray (an ashtray in the image). For example, a feature value of the ashtray that is used in the sales or eating establishment may be registered in advance. Furthermore, the determination unit 12 determines whether or not a cigarette butt is accommodated in the extracted ashtray. For example, the color of the bottom surface of the ashtray is set to be different from a color of a cigarette butt, and it may be determined using the difference between the colors whether or not part or the whole of the bottom surface of the ashtray is hidden. Then, in a case where the hidden portion of the bottom surface of the ashtray accounts for a prescribed ratio or more, it may be determined that the cigarette butt is accommodated in the ashtray. It should be noted that, the determination may be made with other methods.

In a case where the ashtray in which the cigarette butt is accommodated is present, the determination unit 12 can determine that a customer who is smoking in the sales or eating establishment is present. Then, in a case where the ashtray in which the cigarette butt is accommodated is not present, the determination unit 12 can determine that a customer who is smoking in the sales or eating establishment is not present. Furthermore, on the basis of the number of ashtrays in which the cigarette butts are accommodated, the determination unit 12 can determine a rate of customers who are smoking in the sales or eating establishment. For example, a correspondence relationship between the number of ashtrays in which the cigarette butts are accommodated, and the rate of customers who are smoking in the sales or eating establishment may be registered in advance for every sales or eating establishment. Then, on the basis of the information and the number of ashtrays in which the cigarette butts are accommodated, which is determined through the image analysis, the determination unit 12 may determine the rate of customers who are smoking in the sales or eating establishment.

### SPECIFIC EXAMPLE 2

For example, the acquisition unit 11 may acquire audio data, which is generated by at least one of a microphone (the sales or eating establishment apparatus 20) that is installed in the sales or eating establishment and the user terminal 30 that the customer carries with him/her in the sales or eating establishment, as the real-time sales-or-eating-establishment information. Then, on the basis of the audio data, the determination unit 12 may determine a noise annoyance in the sales or eating establishment.

The microphone that is installed in the sales or eating establishment may be installed in a position in which all sound in the entire sales or eating establishment can be collected. One microphone may be installed, and multiple microphones may be installed. The microphone, for example, collects sound at reference setting that is determined in advance and generates audio data. The generated audio data is transmitted from the sales or eating establishment apparatus 20 to the information providing apparatus 10 with as little time loss as possible after the image data is generated.

The determination unit 12 analyzes the acquired audio data and determines a situation of the sales or eating establishment that includes the noise annoyance in the sales or eating establishment. For example, the noise annoyance in the sales or eating establishment may be graded to multiple levels, “silent”, “normal”, “noisy”, and so forth. Then, for example, on the basis of a sound pressure level or the like, the determination unit 12 may determine at which level the noise annoyance in the sales or eating establishment is.

It should be noted that, in the case of the example described above, instead of the audio data that is generated by the microphone (the sales or eating establishment apparatus 20) which is installed in the sales or eating establishment, the process described above may be performed using the audio data that is generated by the user terminal 30 that the customer carries with him/her in the sales or eating establishment. When the user collects the sound in the sales or eating establishment using the user terminal 30 to generate the audio data, the user transmits the audio data from the user terminal 30 to the information providing apparatus 10, in association with the information for identifying the sales or eating establishment (the sales or eating establishment on which information is to be provided).

In this case, using metadata (for example, a place of sound collection, the date and time of sound collecting, and the like) of the audio data that is acquired from the user terminal 30, the determination unit 12 may determine whether or not to use the audio data as the information for determining a current situation of the sales or eating establishment. A specific example of determination process is the same as that described above.

### SPECIFIC EXAMPLE 3

For example, the acquisition unit 11 may acquire information indicating at least one of the ratio between male customers and female customers present in the sales or eating establishment, the ratio of customers present in the sales or eating establishment per age bracket, the noise annoyance in the sales or eating establishment, the presence or absence of a child in the sales or eating establishment, the rate of children in the sales or eating establishment, the presence or absence of a customer who is smoking in the sales or eating establishment, the rate of customers who are smoking in the sales or eating establishment, the presence or absence of an unoccupied smoking seat in the sales or eating establishment, the presence or absence of an unoccupied no-smoking seat in the sales or eating establishment, and the out-of-stock item, as the real-time sales-or-eating-establishment information, from a POS system that is installed in the sales or eating establishment.

Then, on the basis of the information that is acquired from the POS system, the determination unit 12 may determine a situation of the sales or eating establishment that includes at least one of the ratio between male customers and female customers present in the sales or eating establishment, the rate of customers in the sales or eating establishment per age bracket, the noise annoyance in the sales or eating establishment, the presence or absence of a child in the sales or eating establishment, the rate of children in the sales or eating establishment, the presence or absence of a customer who is smoking in the sales or eating establishment, the rate of customers who are smoking in the sales or eating establishment, the presence or absence of an unoccupied smoking seat in the sales or eating establishment, the presence or absence of an unoccupied no-smoking seat in the sales or eating establishment, and the out-of-stock item.

The staff member of the sales or eating establishment may periodically input into the POS system at least one of the ratio between male customers and female customers present in the sales or eating establishment, the ratio of customers present in the sales or eating establishment per age bracket, the presence or absence of a child in the sales or eating establishment, the rate of children in the sales or eating establishment, the presence or absence of an unoccupied smoking seat in the sales or eating establishment, the presence or absence of an unoccupied no-smoking seat in the sales or eating establishment, and the out-of-stock item. For example, each time a customer comes and goes, or each time an out-of-stock item occurs, the staff member of the sales or eating establishment may input the latest information. The POS system stores the information that is input. Then, at any timing (for example, each time the information described above is changed, or every prescribed time), the POS system transmits pieces of the latest information on the various points described above, which are stored, to the information providing apparatus 10.

### SPECIFIC EXAMPLE 4

For example, the acquisition unit 11 may acquire the information indicating at least one of the ratio between male customers and female customers present in the sales or eating establishment, the ratio of customers present in the sales or eating establishment per age bracket, the noise annoyance in the sales or eating establishment, the presence or absence of a child in the sales or eating establishment, the rate of children in the sales or eating establishment, the presence or absence of a customer who is smoking in the sales or eating establishment, the rate of customers who are smoking in the sales or eating establishment, the presence or absence of an unoccupied smoking seat in the sales or eating establishment, the presence or absence of an unoccupied no-smoking seat in the sales or eating establishment, and the out-of-stock item, as the real-time sales-or-eating-establishment information, from the user terminal 30 that the customer carries with him/her in the sales or eating establishment.

Then, on the basis of the information that is acquired from the user terminal 30, the determination unit 12 may determine a situation of the sales or eating establishment that includes at least one of the ratio between male customers and female customers present in the sales or eating establishment, the rate of customers in the sales or eating establishment per age bracket, the noise annoyance in the sales or eating establishment, the presence or absence of a child in the sales or eating establishment, the rate of children in the sales or eating establishment, the presence or absence of a customer who is smoking in the sales or eating establishment, the rate of customers who are smoking in the sales or eating establishment, the presence or absence of an unoccupied smoking seat in the sales or eating establishment, the presence or absence of an unoccupied no-smoking seat in the sales or eating establishment, and the out-of-stock item.

The user inputs the real-time sales-or-eating-establishment information (for example, the ratio between male customers and female customers present in the sales or eating establishment, or the like), which is described above, into the user terminal 30 and transmits the real-time sales-or-eating-establishment information from the user terminal 30 to the information providing apparatus 10, in association with the information for identifying the sales or eating establishment (the sales or eating establishment on which information is to be provided). In this case, the user terminal 30 may further transmit positional information on the user terminal 30 itself to the information providing apparatus 10. Using the positional information that is acquired from the user terminal 30, the determination unit 12 may determine whether or not to use the real-time sales-or-eating-establishment information that is acquired from the user terminal 30 as the information for determining a current situation of the sales or eating establishment.

For example, it may be determined whether or not a position of the user terminal 30 is within the sales or eating establishment on which information is to be provided. Then, in a case where the position of the user terminal 30 is within the sales or eating establishment on which information is to be provided, the position may be used as the information for determining a current situation of the sales or eating establishment on which information is to be provided. In a case where the position of the user terminal 30 is not within the sales or eating establishment on which information is to be provided, the position may not be used as the information for determining a current situation of the sales or eating establishment on which information is to be provided.

Next, a process in which the determination unit 12 determines the future congested situation of the sales or eating establishment will be described. The determination unit 12 may determine the future congested situation of the sales or eating establishment, on the basis of the latest value at least one of a ratio between male customers and female customers present in a sales or eating establishment, a rate of customers in the sales or eating establishment per age bracket, a noise annoyance in the sales or eating establishment, the presence or absence of a child in the sales or eating establishment, the rate of children in the sales or eating establishment, the presence or absence of a customer who is smoking in the sales or eating establishment, a rate of customers who are smoking in the sales or eating establishment, the presence or absence of an unoccupied smoking seat in the sales or eating establishment, the presence or absence of an unoccupied no-smoking seat in the sales or eating establishment, and an out-of-stock item that are determined on the basis of the real-time sales-or-eating-establishment information.

It should be noted that, in addition, the determination unit 12 may determine the future congested situation of the sales or eating establishment, further using at least one of a temporal change until that time in that day in at least one of the multiple points described above, an attribute (for example, a month, a day of the week, weather, a season, or the like) of that day, and a congested situation of the sales or eating establishment at that time. The congested situation of the sales or eating establishment at that time, for example, can be determined on the basis of the real-time sales-or-eating-establishment information described. For example, the number of customers in the sales or eating establishment may be determined through the method that is described in Specific Example 1-1, and the congested situation may be determined on the basis of the number of customers and the number of seats of the sales or eating establishment. The congested situation may be expressed in terms of multiple levels, such as congestion levels 1 to 5, and may be expressed in percentage (for example, the congested situation=the number of customers/the number of seats).

The determination unit 12 can generate an estimation model by machine learning that is based on multiple pieces of data, such as a congested situation during the past business hours in each sales or eating establishment, an attribute (for example, a month, a day of the week, weather, a season, or the like) of each day, and a temporal change of each day in at least one of the multiple points described above, and can determine the future congested situation on the basis of the estimation model. For example, a heterogeneous mixture learning model may be used in which pieces of input data are case-divided according to a rule in the form of a decision tree and prediction is made with a linear model in which explanatory variables different for each case are combined. This technology is known as “heterogeneous mixture learning technology.” The technology is disclosed in Non-patent Document 1.

For example, the case-dividing may be made on a per-month basis, on a per-day-of-the-week basis, on a per-weather basis, on a per-time-of-day basis, on a per-season basis, according to a ratio between men and women, according to a ratio among age brackets, on a per-noise-annoyance-in-the-sales or eating establishment basis, according to the presence or absence of a child in the sales or eating establishment, according to a rate of children in the sales or eating establishment, according to the present or absence of a customer who is smoking in the sales or eating establishment, according to a ratio of customers who are smoking in the sales or eating establishment, according to the presence or absence of an unoccupied smoking seat in the sales or eating establishment, according to the presence or absence of an unoccupied no-smoking seat in the sales or eating establishment, according to the presence or absence of an out-of-stock item, and according to a type of out-of-stock item.

The determination unit 12 may determine a congested situation of the sales or eating establishment after a prescribed time elapses from that time (after 5 minutes, 15 minutes, or 30 minutes), a temporal change in the future congested situation of the sales or eating establishment, and the like, using the estimation model, the latest value of at least one of the multiple points described above, a temporal change until that time in that day in at least one of the multiple points described above, an attribute (for example, a month, a day of the week, weather, a season, or the like) of that day, a congested situation of the sales or eating establishment at that time, and the like.

With reference again to FIG. 3, the output unit 13 outputs at least one of a result of the determination by the determination unit 12 and information for identifying a sales or eating establishment having a result of the determination that satisfies the search condition. For example, the request acquisition unit 15 (refer to FIG. 7) may acquire a request for information from the user terminal 30. Then, the output unit 13 may transmit prescribed information to the user terminal 30 according to the request.

For example, the user operates the user terminal 30, specifies an arbitrary “sales or eating establishment”, and thus may transmit a request (a sales or eating establishment situation request) for information indicating a current situation of the sales or eating establishment, to the information providing apparatus 10. The request acquisition unit 15 can acquire the sales or eating establishment situation request. Then, according to the sales or eating establishment situation request, the output unit 13 may reply to the user terminal 30 with the latest result of the determination of the specified sales or eating establishment.

In addition, the user operates the user terminal 30, specifies an arbitrary “situation of a sales or eating establishment”, and thus may transmit a request for a sales or eating establishment that satisfies the situation (the search condition), to the information providing apparatus 10. The request acquisition unit 15 can acquire the request. Then, the output unit 13 may extract a sales or eating establishment having the latest result of the determination that satisfies (is consistent with) the specified search condition, according to the request and may reply to the user terminal 30 with information for identifying the sales or eating establishment.

The search condition in this example, for example, is a condition of specifying at least one of the ratio between male customers and female customers present in the sales or eating establishment, the rate of customers in the sales or eating establishment per age bracket, the noise annoyance in the sales or eating establishment, the presence or absence of a child in the sales or eating establishment, the rate of children in the sales or eating establishment, the presence or absence of a customer who is smoking in the sales or eating establishment, the rate of customers who are smoking in the sales or eating establishment, the presence or absence of an unoccupied smoking seat in the sales or eating establishment, the presence or absence of an unoccupied no-smoking seat in the sales or eating establishment, the out-of-stock item, and the future congested situation of the sales or eating establishment. It should be noted that, in a case where two or more of them are specified, it is assumed that the two or more of them can be linked to each using a prescribed logical equation.

It should be noted that, in the request that specifies a “situation of a sales or eating establishment”, searched sales or eating establishments may be able to be further narrowed down using a sales or eating establishment location or a sales or eating establishment category.

Next, an example of a processing flow of the information providing apparatus 10 according to the present example embodiment will be described. First, the acquisition unit 11 continues to acquire the real-time sales-or-eating-establishment information. Furthermore, the determination unit 12 continues a process that determines a current situation of the sales or eating establishment on the basis of the real-time sales-or-eating-establishment information. Accordingly, information indicating the current situation of each sales or eating establishment as illustrated in FIG. 4 is maintained at the latest state. A process by the output unit 13 is performed concurrently with these processes.

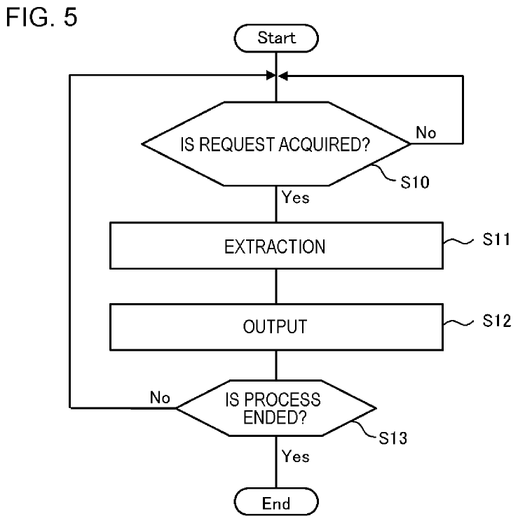

Using a flowchart in FIG. 5, an example of a processing flow of the output unit 13 is described.

The output unit 13 enters a state of waiting to acquire the request from the user terminal 30 (S10).

When the request acquisition unit 15 acquires the request that specifies the sales or eating establishment, the acquisition unit 11 extracts the latest result of the determination of the sales or eating establishment that is specified with the request, from the information that is illustrated in FIG. 4 (S11). Then, the acquisition unit 11 outputs the extracted information toward the user terminal 30 (S12).

Furthermore, when the request acquisition unit 15 acquires the request that specifies a situation of the sales or eating establishment, the acquisition unit 11 extracts a sales or eating establishment that satisfies the situation of the sales or eating establishment which is specified with the request, for example, from the information that is illustrated in FIG. 4 (S11). Then, the acquisition unit 11 outputs information for identifying the extracted sales or eating establishment, toward the user terminal 30 (S12).

As long as there is no instruction to end the process (No in S13), the process described above is repeated.

With the information providing apparatus 10 according to the present example embodiment, which is described above, a current situation of the sales or eating establishment can be determined on the basis of the real-time sales-or-eating-establishment information that is acquired from at least one of the sales or eating establishment apparatus 20 that is installed in the sales or eating establishment, and the user terminal 30 that the customer carries with him/her in the sales or eating establishment.

For example, at least one of the ratio between male customers and female customers present in the sales or eating establishment, the rate of customers in the sales or eating establishment per age bracket, the noise annoyance in the sales or eating establishment, the presence or absence of a child in the sales or eating establishment, the rate of children in the sales or eating establishment, the presence or absence of a customer who is smoking in the sales or eating establishment, the rate of customers who are smoking in the sales or eating establishment, the presence or absence of an unoccupied smoking seat in the sales or eating establishment, the presence or absence of an unoccupied no-smoking seat in the sales or eating establishment, the out-of-stock item, and the future congested situation of the sales or eating establishment can be determined.

Then, the information providing apparatus 10 can provide beneficial information to the user, on the basis of the determined information.

For example, the information indicating a current situation of the sales or eating establishment that is specified by the user can be provided, or the information for identifying the sales or eating establishment that satisfies a “situation of n sales or eating establishment” that is specified by the user can be provided.

The user can recognize a current situation of each sales or eating establishment, on the basis of the information that is acquired from the information providing apparatus 10. Then, on the basis of details of the current situation, the sales or eating establishment that is to be used can be determined from the detail.

With the information providing apparatus 10, the user can efficiently find a sales or eating establishment that is in his/her favorite situation at that time. As a result, the user can reduce the time taken to search for a sales or eating establishment.

Furthermore, the information providing apparatus 10 according to the present example embodiment can estimate a future congested situation of the sales or eating establishment, on the basis of a current situation of the sales or eating establishment that is indicated by at least one of the ratio between male customers and female customers present in the sales or eating establishment, the rate of customers in the sales or eating establishment per age bracket, the noise annoyance in the sales or eating establishment, the presence or absence of a child in the sales or eating establishment, the rate of children in the sales or eating establishment, the presence or absence of a customer who is smoking in the sales or eating establishment, the rate of customers who are smoking in the sales or eating establishment, the presence or absence of an unoccupied smoking seat in the sales or eating establishment, the presence or absence of an unoccupied no-smoking seat in the sales or eating establishment, and the out-of-stock item. As a result, the precision of the estimation is improved.

Furthermore, in a case where the information providing apparatus 10 acquires the real-time sales-or-eating-establishment information from the user terminal 30 and does not acquire the real-time sales-or-eating-establishment information from the sales or eating establishment apparatus 20, the information providing system may not have the sales or eating establishment apparatus 20. In this case, without installing new equipment (the sales or eating establishment apparatus 20) in the sales or eating establishment, the system can be operated. As a result, the burden of investment in equipment can be reduced.

### Second Example Embodiment

The information providing apparatus 10 according to the present example embodiment can calculate a trend of the result of the determination in each sales or eating establishment for every time slot, on the basis of accumulation data that results from accumulating the result of the determination by the determination unit 12, in addition to performing the function that is described in the first example embodiment. Then, the information providing apparatus 10 can provide information indicating the trend to the user.

In the same manner as in the first example embodiment, the information providing system according to the present example embodiment has the information providing apparatus 10, the sales or eating establishment apparatus 20, and the user terminal 30. These apparatuses are linked to each other, for example, through a communication network 40 such as the Internet and transmit and receive information to and from each other. It should be noted that, as described in the first example embodiment, the information providing system may not have the sales or eating establishment apparatus 20.

Configurations of the sales or eating establishment apparatus 20 and the user terminal 30 are the same as those in the first example embodiment.

A configuration of the information providing apparatus 10 will be described below. An example of a hardware configuration of the information providing apparatus 10 is the same as that in the first example embodiment.

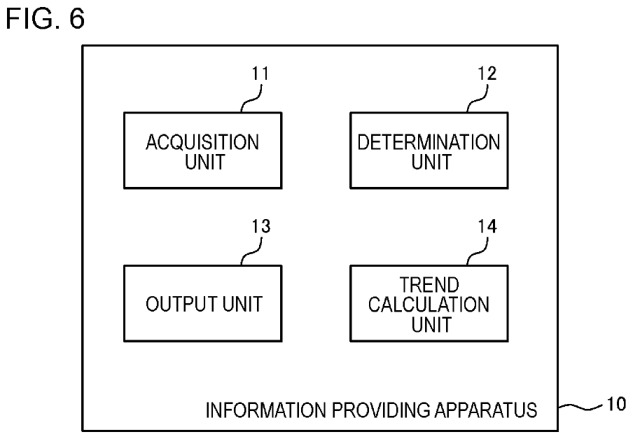

FIG. 6 illustrates an example of a functional block diagram of the information providing apparatus 10 according to the present example embodiment. As illustrated, the information providing apparatus 10 has the acquisition unit 11, the determination unit 12, the output unit 13, and a trend calculation unit 14. Although not illustrated, the information providing apparatus 10 may further include the request acquisition unit 15. Configurations of the acquisition unit 11 and the determination unit 12 are the same as those in the first example embodiment.

On the basis of the accumulation data that results from accumulating the result of the determination made by the determination unit 12, the trend calculation unit 14 calculates the trend of the result of the determination in each sales or eating establishment for every time slot. It should be noted that, the trend calculation unit 14 may divide cases according to another factor such as a month, a day of the week, weather, or a season and may calculate the trend of the result of the determination in each case for every slot.

For example, the trend calculation unit 14 may calculate a value that has the highest probability for every time slot (a value that appears most frequently in each time slot in the accumulation data), corresponding to at least one of the ratio between male customers and female customers present in the sales or eating establishment, the rate of customers in the sales or eating establishment per age bracket, the noise annoyance in the sales or eating establishment, the presence or absence of a child in the sales or eating establishment, the rate of children in the sales or eating establishment, the presence or absence of a customer who is smoking in the sales or eating establishment, the rate of customers who are smoking in the sales or eating establishment, the presence or absence of an unoccupied smoking seat in the sales or eating establishment, the presence or absence of an unoccupied no-smoking seat in the sales or eating establishment, and the out-of-stock item.

The output unit 13 outputs a result of the calculation by the trend calculation unit 14.

For example, the user operates the user terminal 30, specifies an arbitrary “sales or eating establishment”, and thus may transmit a request (a trend request) for information indicating the trend of the situation of the sales or eating establishment for every time slot to the information providing apparatus 10. The request acquisition unit 15 may acquire the trend request from the user terminal 30. Then, according to the trend request, the output unit 13 may reply to the user terminal 30 with the result of the calculation by the trend calculation unit 14, which corresponds to the specified sales or eating establishment.

In addition, the user operates the user terminal 30, specifies not only an arbitrary “sales or eating establishment” but also a time slot. Thus, the user may transmit the request (the trend request) for the information indicating the trend of the sales or eating establishment for the time slot to the information providing apparatus 10. The request acquisition unit 15 may acquire the trend request from the user terminal 30. Then, according to the trend request, the output unit 13 may reply to the user terminal 30 with the result of the calculation by the trend calculation unit 14, which corresponds to the specified time slot in the specified sales or eating establishment.

It should be noted that, in the same manner as in the first example embodiment, the output unit 13 may further output at least one of the result of the determination by the determination unit 12 and the information for identifying a sales or eating establishment having a result of the determination that satisfies the search condition. Furthermore, the request acquisition unit 15 may further acquire the request, which is described in the first example embodiment, from the user terminal 30.

An example of a process of the information providing apparatus 10 according to the present example embodiment is the same as in the first example embodiment.

With the information providing apparatus 10 according to the present example embodiment can achieve the same advantageous effect as in the first example embodiment. Furthermore, the information providing apparatus 10 according to the present example embodiment can calculate the trend of the situation of each sales or eating establishment for every time slot and can provide the calculated tendency to the user.

With the information providing apparatus 10, the user can efficiently find a sales or eating establishment that is in his/her favorite situation at that time or a sales or eating establishment that has a high likelihood of being in his/her favorite situation in the future. As a result, the user can reduce the time taken to search for a sales or eating establishment.

Example of a reference example embodiment will be added as appendixes as follows.

1. An information providing apparatus, including: an acquisition unit that acquires real-time sales-or-eating-establishment information from at least one of an apparatus that is installed in a sales or eating establishment, and a user terminal that a customer carries with him/her in the sales or eating establishment; a determination unit that, on the basis of the real-time sales-or-eating-establishment information, determines a situation of the sales or eating establishment which includes at least one of a ratio between male customers and female customers present in the sales or eating establishment, a rate of customers in the sales or eating establishment per age bracket, a noise annoyance in the sales or eating establishment, the presence or absence of a child in the sales or eating establishment, a rate of children in the sales or eating establishment, the presence or absence of a customer who is smoking in the sales or eating establishment, a rate of customers who are smoking in the sales or eating establishment, the presence or absence of an unoccupied smoking seat in the sales or eating establishment, the presence or absence of an unoccupied no-smoking seat in the sales or eating establishment, an out-of-stock item, and a future congested situation of the sales or eating establishment; and an output unit that outputs a result of the determination by the determination unit.

2. The information providing apparatus according to (1), in which the acquisition unit acquires image data that is generated by at least one of a camera which is installed in the sales or eating establishment and the user terminal, as the real-time sales-or-eating-establishment information, and in which, on the basis of the image data, the determination unit determines the situation of the sales or eating establishment that includes at least one of the ratio between male customers and female customers present in the sales or eating establishment, the rate of customers in the sales or eating establishment per age bracket, the presence or absence of a child in the sales or eating establishment, the rate of children in the sales or eating establishment, the presence or absence of a customer who is smoking in the sales or eating establishment, the rate of customers who are smoking in the sales or eating establishment, the presence or absence of an unoccupied smoking seat in the sales or eating establishment, and the presence or absence of an unoccupied no-smoking seat in the sales or eating establishment.

3. The information providing apparatus according to (1) or (2), in which the acquisition unit acquires audio data that is generated by at least one of a microphone which is installed in the sales or eating establishment and the user terminal, as the real-time sales-or-eating-establishment information, and in which, on the basis of the audio data, the determination unit determines the situation of the sales or eating establishment that includes the noise annoyance in the sales or eating establishment.

4. The information providing apparatus according to any one (1) 1 to (3), in which the acquisition unit acquires information indicating at least one of the ratio between male customers and female customers present in the sales or eating establishment, the rate of customers in the sales or eating establishment per age bracket, the noise annoyance in the sales or eating establishment, the presence or absence of a child in the sales or eating establishment, the rate of children in the sales or eating establishment, the presence or absence of a customer who is smoking in the sales or eating establishment, the rate of customers who are smoking in the sales or eating establishment, the presence or absence of an unoccupied smoking seat in the sales or eating establishment, the presence or absence of an unoccupied no-smoking seat in the sales or eating establishment, and the out-of-stock item, as the real-time sales-or-eating-establishment information, from a point of sales (POS) system installed in the sales or eating establishment, and in which, on the basis of the information that is acquired from the POS system, the determination unit that determines the situation of the sales or eating establishment which includes at least one of the ratio between male customers and female customers present in the sales or eating establishment, the rate of customers in the sales or eating establishment per age bracket, the noise annoyance in the sales or eating establishment, the presence or absence of a child in the sales or eating establishment, the rate of children in the sales or eating establishment, the presence or absence of a customer who is smoking in the sales or eating establishment, the rate of customers who are smoking in the sales or eating establishment, the presence or absence of an unoccupied smoking seat in the sales or eating establishment, the presence or absence of an unoccupied no-smoking seat in the sales or eating establishment, and the out-of-stock item.

5. The information providing apparatus according to any one of (1) to (4), in which the acquisition unit acquires information indicating at least one of the ratio between male customers and female customers present in the sales or eating establishment, the rate of customers in the sales or eating establishment per age bracket, the noise annoyance in the sales or eating establishment, the presence or absence of a child in the sales or eating establishment, the rate of children in the sales or eating establishment, the presence or absence of a customer who is smoking in the sales or eating establishment, the rate of customers who are smoking in the sales or eating establishment, the presence or absence of an unoccupied smoking seat in the sales or eating establishment, the presence or absence of an unoccupied no-smoking seat in the sales or eating establishment, and the out-of-stock item, as the real-time sales-or-eating-establishment information, from the user terminal, and in which, on the basis of the information that is acquired from the user terminal, the determination unit determines the situation of the sales or eating establishment that includes at least one of the ratio between male customers and female customers present in the sales or eating establishment, the rate of customers in the sales or eating establishment per age bracket, the noise annoyance in the sales or eating establishment, the presence or absence of a child in the sales or eating establishment, the rate of children in the sales or eating establishment, the presence or absence of a customer who is smoking in the sales or eating establishment, the rate of customers who are smoking in the sales or eating establishment, the presence or absence of an unoccupied smoking seat in the sales or eating establishment, the presence or absence of an unoccupied no-smoking seat in the sales or eating establishment, and the out-of-stock item.

6. The information providing apparatus according to any one of (1) to (5), in which the determination unit determines the situation of the sales or eating establishment that includes the future congested situation of the sales or eating establishment, on the basis of at least one of the ratio between male customers and female customers present in the sales or eating establishment, the rate of customers in the sales or eating establishment per age bracket, the noise annoyance in the sales or eating establishment, the presence or absence of a child in the sales or eating establishment, the rate of children in the sales or eating establishment, the presence or absence of a customer who is smoking in the sales or eating establishment, the rate of customers who are smoking in the sales or eating establishment, the presence or absence of an unoccupied smoking seat in the sales or eating establishment, the presence or absence of an unoccupied no-smoking seat in the sales or eating establishment, and the out-of-stock item, which are determined on the basis of the real-time sales-or-eating-establishment information.

7. The information providing apparatus according to any one of (1) to (6), further including: a trend calculation unit that calculates a trend of a result of the determination in the sales or eating establishment for every time slot, on the basis of accumulation data that results from accumulating the result of the determination by the determination unit, in which the output unit further outputs a result of the calculation by the trend calculation unit.

8. The information providing apparatus according to any one of (1) to (7), further including: a request acquisition unit that acquires a request which specifies the situation of the sales or eating establishment, in which the output unit outputs information for identifying a sales or eating establishment having a result of the determination that satisfies the situation of the sales or eating establishment which is specified with the request.

9. A method of providing information, which is performed by a computer, the method including: a process of acquiring real-time sales-or-eating-establishment information from at least one of an apparatus that is installed in a sales or eating establishment, and a user terminal that a customer carries with him/her in the sales or eating establishment; a process of determining a situation of the sales or eating establishment which includes at least one of a ratio between male customers and female customers present in the sales or eating establishment, a rate of customers in the sales or eating establishment per age bracket, a noise annoyance in the sales or eating establishment, the presence or absence of a child in the sales or eating establishment, a rate of children in the sales or eating establishment, the presence or absence of a customer who is smoking in the sales or eating establishment, a rate of customers who are smoking in the sales or eating establishment, the presence or absence of an unoccupied smoking seat in the sales or eating establishment, the presence or absence of an unoccupied no-smoking seat in the sales or eating establishment, an out-of-stock item, and a future congested situation of the sales or eating establishment, on the basis of the real-time sales-or-eating-establishment information; and a process of outputting a result of the determination in the determination process.

10. A program that causes a computer to function as: an acquisition unit that acquires real-time sales-or-eating-establishment information from at least one of an apparatus that is installed in a sales or eating establishment, and a user terminal that a customer carries with him/her in the sales or eating establishment; a determination unit that determines a situation of the sales or eating establishment which includes at least one of a ratio between male customers and female customers present in the sales or eating establishment, a rate of customers in the sales or eating establishment per age bracket, a noise annoyance in the sales or eating establishment, the presence or absence of a child in the sales or eating establishment, a rate of children in the sales or eating establishment, the presence or absence of a customer who is smoking in the sales or eating establishment, a rate of customers who are smoking in the sales or eating establishment, the presence or absence of an unoccupied smoking seat in the sales or eating establishment, the presence or absence of an unoccupied no-smoking seat in the sales or eating establishment, an out-of-stock item, and a future congested situation of the sales or eating establishment, on the basis of the real-time sales-or-eating-establishment information; and an output unit that outputs a result of the determination by the determination unit.

This application claims priority based on Japanese Patent Application No. 2017-052264, filed on Mar. 17, 2017, the contents of which is incorporated by reference herein in its entirety.

1. An information providing apparatus, comprising:
at least one memory configured to store one or more instructions; and
at least one processor configured to execute the one or more instructions to:
acquire real-time sales-or-eating-establishment information from at least one of an apparatus that is installed in a sales or eating establishment, and a user terminal that a customer carries with him/her in the sales or eating establishment;
determine, on the basis of the real-time sales-or-eating-establishment information, a situation of the sales or eating establishment which includes at least one of a ratio between male customers and female customers present in the sales or eating establishment, a rate of customers in the sales or eating establishment per age bracket, a noise annoyance in the sales or eating establishment, the presence or absence of a child in the sales or eating establishment, a rate of children in the sales or eating establishment, the presence or absence of a customer who is smoking in the sales or eating establishment, a rate of customers who are smoking in the sales or eating establishment, the presence or absence of an unoccupied smoking seat in the sales or eating establishment, the presence or absence of an unoccupied no-smoking seat in the sales or eating establishment, an out-of-stock item, and a future congested situation of the sales or eating establishment; and
output a result of the determination.

2. The information providing apparatus according to claim 1,
wherein the processor is further configured to execute the one or more instructions to:
acquire image data that is generated by at least one of a camera which is installed in the sales or eating establishment and the user terminal, as the real-time sales-or-eating-establishment information, and
determine, on the basis of the image data, the situation of the sales or eating establishment that includes at least one of the ratio between male customers and female customers present in the sales or eating establishment, the rate of customers in the sales or eating establishment per age bracket, the presence or absence of a child in the sales or eating establishment, the rate of children in the sales or eating establishment, the presence or absence of a customer who is smoking in the sales or eating establishment, the rate of customers who are smoking in the sales or eating establishment, the presence or absence of an unoccupied smoking seat in the sales or eating establishment, and the presence or absence of an unoccupied no-smoking seat in the sales or eating establishment.

3. The information providing apparatus according to claim 1,
wherein the processor is further configured to execute the one or more instructions to:
acquire audio data that is generated by at least one of a microphone which is installed in the sales or eating establishment and the user terminal, as the real-time sales-or-eating-establishment information, and
determine, on the basis of the audio data, the situation of the sales or eating establishment that includes the noise annoyance in the sales or eating establishment.

4. The information providing apparatus according to claim 1,
wherein the processor is further configured to execute the one or more instructions to:
acquire information indicating at least one of the ratio between male customers and female customers present in the sales or eating establishment, the rate of customers in the sales or eating establishment per age bracket, the noise annoyance in the sales or eating establishment, the presence or absence of a child in the sales or eating establishment, the rate of children in the sales or eating establishment, the presence or absence of a customer who is smoking in the sales or eating establishment, the rate of customers who are smoking in the sales or eating establishment, the presence or absence of an unoccupied smoking seat in the sales or eating establishment, the presence or absence of an unoccupied no-smoking seat in the sales or eating establishment, and the out-of-stock item, as the real-time sales-or-eating-establishment information, from a point of sales (POS) system installed in the sales or eating establishment, and
determine, on the basis of the information that is acquired from the POS system, the situation of the sales or eating establishment which includes at least one of the ratio between male customers and female customers present in the sales or eating establishment, the rate of customers in the sales or eating establishment per age bracket, the noise annoyance in the sales or eating establishment, the presence or absence of a child in the sales or eating establishment, the rate of children in the sales or eating establishment, the presence or absence of a customer who is smoking in the sales or eating establishment, the rate of customers who are smoking in the sales or eating establishment, the presence or absence of an unoccupied smoking seat in the sales or eating establishment, the presence or absence of an unoccupied no-smoking seat in the sales or eating establishment, and the out-of-stock item.

5. The information providing apparatus according to claim 1,
wherein the processor is further configured to execute the one or more instructions to:
acquire information indicating at least one of the ratio between male customers and female customers present in the sales or eating establishment, the rate of customers in the sales or eating establishment per age bracket, the noise annoyance in the sales or eating establishment, the presence or absence of a child in the sales or eating establishment, the rate of children in the sales or eating establishment, the presence or absence of a customer who is smoking in the sales or eating establishment, the rate of customers who are smoking in the sales or eating establishment, the presence or absence of an unoccupied smoking seat in the sales or eating establishment, the presence or absence of an unoccupied no-smoking seat in the sales or eating establishment, and the out-of-stock item, as the real-time sales-or-eating-establishment information, from the user terminal, and
determine, on the basis of the information that is acquired from the user terminal, the situation of the sales or eating establishment that includes at least one of the ratio between male customers and female customers present in the sales or eating establishment, the rate of customers in the sales or eating establishment per age bracket, the noise annoyance in the sales or eating establishment, the presence or absence of a child in the sales or eating establishment, the rate of children in the sales or eating establishment, the presence or absence of a customer who is smoking in the sales or eating establishment, the rate of customers who are smoking in the sales or eating establishment, the presence or absence of an unoccupied smoking seat in the sales or eating establishment, the presence or absence of an unoccupied no-smoking seat in the sales or eating establishment, and the out-of-stock item.

6. The information providing apparatus according to claim 1,
wherein the processor is further configured to execute the one or more instructions to determine the situation of the sales or eating establishment that includes the future congested situation of the sales or eating establishment, on the basis of at least one of the ratio between male customers and female customers present in the sales or eating establishment, the rate of customers in the sales or eating establishment per age bracket, the noise annoyance in the sales or eating establishment, the presence or absence of a child in the sales or eating establishment, the rate of children in the sales or eating establishment, the presence or absence of a customer who is smoking in the sales or eating establishment, the rate of customers who are smoking in the sales or eating establishment, the presence or absence of an unoccupied smoking seat in the sales or eating establishment, the presence or absence of an unoccupied no-smoking seat in the sales or eating establishment, and the out-of-stock item, which are determined on the basis of the real-time sales-or-eating-establishment information.

7. The information providing apparatus according to claim 1,
wherein the processor is further configured to execute the one or more instructions to:
calculate a trend of a result of the determination in the sales or eating establishment for every time slot, on the basis of accumulation data that results from accumulating the result of the determination, and
output a result of the calculation.

8. The information providing apparatus according to claim 1,
wherein the processor is further configured to execute the one or more instructions to:
acquire a request which specifies the situation of the sales or eating establishment, and
output information for identifying a sales or eating establishment having a result of the determination that satisfies the situation of the sales or eating establishment which is specified with the request.

9. A method of providing information, which is performed by a computer, the method comprising:
acquiring real-time sales-or-eating-establishment information from at least one of an apparatus that is installed in a sales or eating establishment, and a user terminal that a customer carries with him/her in the sales or eating establishment;
determining a situation of the sales or eating establishment which includes at least one of a ratio between male customers and female customers present in the sales or eating establishment, a rate of customers in the sales or eating establishment per age bracket, a noise annoyance in the sales or eating establishment, the presence or absence of a child in the sales or eating establishment, a rate of children in the sales or eating establishment, the presence or absence of a customer who is smoking in the sales or eating establishment, a rate of customers who are smoking in the sales or eating establishment, the presence or absence of an unoccupied smoking seat in the sales or eating establishment, the presence or absence of an unoccupied no-smoking seat in the sales or eating establishment, an out-of-stock item, and a future congested situation of the sales or eating establishment, on the basis of the real-time sales-or-eating-establishment information; and
outputting a result of the determination.

10. A non-transitory storage medium storing a program that causes a computer to:
acquire real-time sales-or-eating-establishment information from at least one of an apparatus that is installed in a sales or eating establishment, and a user terminal that a customer carries with him/her in the sales or eating establishment;
determine a situation of the sales or eating establishment which includes at least one of a ratio between male customers and female customers present in the sales or eating establishment, a rate of customers in the sales or eating establishment per age bracket, a noise annoyance in the sales or eating establishment, the presence or absence of a child in the sales or eating establishment, a rate of children in the sales or eating establishment, the presence or absence of a customer who is smoking in the sales or eating establishment, a rate of customers who are smoking in the sales or eating establishment, the presence or absence of an unoccupied smoking seat in the sales or eating establishment, the presence or absence of an unoccupied no-smoking seat in the sales or eating establishment, an out-of-stock item, and a future congested situation of the sales or eating establishment, on the basis of the real-time sales-or-eating-establishment information; and
output a result of the determination.
